(19) United States
(12) Patent Application Publication
(10) Pub. No.: US 2025/0100526 A1
(43) Pub. Date: Mar. 27, 2025

(54) ELECTRO-HYDRAULIC BRAKE SYSTEM

(71) Applicant: HYUNDAI MOBIS CO., LTD., Seoul (KR)

(72) Inventor: Sung Ki AHN, Yongin-si (KR)

(73) Assignee: HYUNDAI MOBIS CO., LTD., Seoul (KR)

(21) Appl. No.: 18/390,584

(22) Filed: Dec. 20, 2023

(30) Foreign Application Priority Data
Sep. 22, 2023 (KR) 10-2023-0127062

(51) Int. Cl. B60T 13/68; B60T 8/40; B60T 13/74

(52) U.S. Cl. CPC B60T 13/686; B60T 8/4081; B60T 13/745

(57) ABSTRACT

Disclosed herein is an electro-hydraulic brake system that includes a pedal unit, a signal transmission unit configured to transmit a pressure signal of the pedal unit, and a braking unit mounted on each wheel cylinder to supply a braking fluid to the wheel cylinder under control of the signal transmission unit.

### CROSS-REFERENCE TO RELATED APPLICATION

This application claims priority from and the benefit of Korean Patent Application No. 10-2023-0127062, filed on Sep. 22, 2023, which is hereby incorporated by reference for all purposes as if set forth herein.

### BACKGROUND

### Field

Exemplary embodiments of the present disclosure relate to an electro-hydraulic brake system, and more particularly, to an electro-hydraulic brake system that is capable of being mounted on each wheel to provide hydraulic pressure to its wheel cylinder in response to a signal.

### Discussion of the Background

In general, an electro-hydraulic brake system serves to detect a pedal pressure by a driver through a sensor and then to adjust the braking pressure of each wheel with the hydraulic pressure from a master cylinder driven by a motor.

The electro-hydraulic brake system includes a sensor that detects a pedal stroke in order for the driver to know a desired braking pressure.

The electro-hydraulic brake system also includes a pedal travel simulator that allows the driver to feel the same pedal pressure as in a typical hydraulic brake system.

Thus, when the driver presses a brake pedal, an electronic control unit detects it and supplies hydraulic pressure to the master cylinder.

The master cylinder transmits braking hydraulic pressure to the wheel cylinder of each wheel, providing a braking force to the wheel.

In a conventional electro-hydraulic brake system, productivity may be reduced due to the design and installation work of piping to guide hydraulic pressure from a master cylinder to a wheel cylinder. Therefore, there is a need to address such an issue.

The related art of the present disclosure is disclosed in Korean Patent Application Publication No. 2007-0104982 (published on Oct. 30, 2007, entitled “VALVE CONTROL DEVICE FOR ELECTRO-HYDRAULIC BRAKE SYSTEM”).

### SUMMARY

Various embodiments are directed to an electro-hydraulic brake system that is capable of being mounted on each wheel to provide hydraulic pressure to its wheel cylinder in response to a signal.

In an embodiment, there is provided an electro-hydraulic brake system that includes a pedal unit, a signal transmission unit configured to transmit a pressure signal of the pedal unit, and a braking unit mounted on each wheel cylinder to supply a braking fluid to the wheel cylinder under control of the signal transmission unit.

The braking unit may include a block section mounted on the wheel cylinder, a storage section formed in the block section to store the braking fluid therein, a circuit section formed in the block section to adjust the braking fluid, and a control section configured to control the circuit section to supply the braking fluid from the circuit section to the wheel cylinder when the control section detects a control signal from the signal transmission unit.

The block section may include a block body, and a block port formed on the block body to induce connection with the wheel cylinder.

The storage section may include a storage chamber formed inside the block section to store the braking fluid therein, a storage passage extending from the storage chamber to a side of the block section to define a flow path, and a storage plug configured to open or close the storage passage.

The storage plug may block a flow of fluid and permit a flow of gas to maintain an internal pressure of the storage plug at a level of atmospheric pressure.

The storage plug may be made of a sintered metal material.

The circuit section may include a first passage connected to the storage section for supply of the braking fluid, and a second passage configured to connect the first passage to the wheel cylinder and to guide the braking fluid stored in the storage section to the wheel cylinder.

The first passage may include a first line connected to the storage section, and a first drive part formed in the first line to discharge the braking fluid stored in the storage section.

The second passage may include a second line configured to connect the first passage to the wheel cylinder, and a second measurement part configured to measure a pressure of the second line.

The circuit section may include a third passage configured to connect the second passage to the storage section for guidance of the braking fluid, and a fourth passage configured to connect the first passage to the storage section for guidance of the braking fluid.

As apparent from the above description, in the electro-hydraulic brake system according to the present disclosure, when the pressure signal of the pedal unit is transmitted to the braking unit through the signal transmission unit, the braking unit mounted on each wheel cylinder may supply its own stored braking fluid to the wheel cylinder in order to perform braking.

### BRIEF DESCRIPTION OF THE DRAWINGS

FIG. 1 is a block diagram schematically illustrating an electro-hydraulic brake system according to an embodiment of the present disclosure.

FIG. 2 is a diagram schematically illustrating a braking unit according to the embodiment of the present disclosure.

FIG. 3 is a view schematically illustrating a block section according to the embodiment of the present disclosure.

FIG. 4 is a view schematically illustrating a storage section according to the embodiment of the present disclosure.

FIG. 5 is a diagram schematically illustrating a circuit section according to the embodiment of the present disclosure.

FIG. 6 is a diagram schematically illustrating an increased pressure state in the circuit section according to the embodiment of the present disclosure.

FIG. 7 is a diagram schematically illustrating a decreased pressure state in the circuit section according to the embodiment of the present disclosure.

### DETAILED DESCRIPTION OF THE ILLUSTRATED EMBODIMENTS

Hereinafter, an electro-hydraulic brake system according to embodiments of the present disclosure will be described with reference to the accompanying drawings. It should be considered that the thickness of each line or the size of each component in the drawings may be exaggeratedly illustrated for clarity and convenience of description. In addition, the terms used herein are terms defined in consideration of functions of the present disclosure, and these terms may change depending on the intention or practice of a user or an operator. Therefore, these terms should be defined based on the entirety of the disclosure set forth herein.

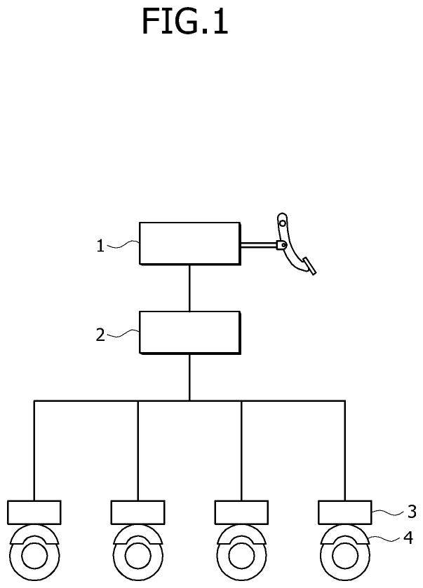

FIG. 1 is a block diagram schematically illustrating an electro-hydraulic brake system according to an embodiment of the present disclosure. Referring to FIG. 1, the electro-hydraulic brake system according to the embodiment of the present disclosure includes a pedal unit 1, a signal transmission unit 2, and a braking unit 3.

The pedal unit 1 may provide a pressure signal by pressing from a driver. For example, the pedal unit 1 may be placed beneath a driver's seat and the driver may press the pedal unit 1 with his/her foot. In addition, in an autonomous driving mode, the pedal unit 1 may be automatically pressed in response to a braking signal.

The signal transmission unit 2 may transmit the pressure signal of the pedal unit 1. For example, the signal transmission unit 2 may transmit pressure signals digitalized from the pressing speed, pressing force, pressing time, and the like of the pedal unit 1 to the braking unit 3 in a wired or wireless manner. Meanwhile, in the autonomous driving mode, a controller may directly transmit a pressure signal to the signal transmission unit 2 without operating the pedal unit 1 in relation to the driving state.

The braking unit 3 may be mounted on each wheel cylinder 4 to supply a braking fluid to the wheel cylinder 4 under the control of the signal transmission unit 2. For example, a total of four front and rear wheels may be disposed in a vehicle and the wheel cylinder 4 may be disposed on each of the front and rear wheels. The wheel cylinder 4 may provide a braking force to each of the front and rear wheels when hydraulic pressure is supplied thereto.

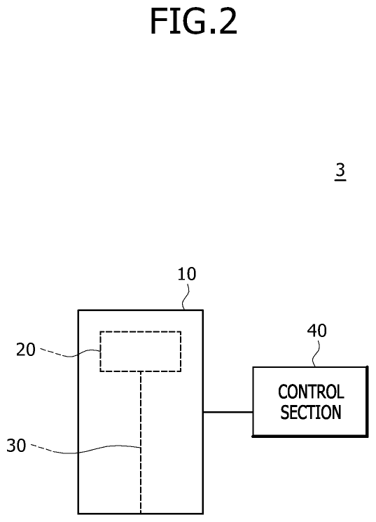

FIG. 2 is a diagram schematically illustrating the braking unit according to the embodiment of the present disclosure. Referring to FIG. 2, the braking unit 3 according to the embodiment of the present disclosure may include a block section 10, a storage section 20, a circuit section 30, and a control section 40.

The block section 10 may be mounted on each wheel cylinder 4. For example, the block section 10 may be integrally connected or coupled to the wheel cylinder 4. In addition, the block section 10 may be mounted on a hub bearing.

The storage section 20 may be formed in the block section 10 and may store braking fluid therein. For example, the storage section 20 may be formed inside the block section 10 and may define a space for storage of braking fluid.

The circuit section 30 may be formed in the block section 10 and may adjust braking fluid. For example, the circuit section 30 may be formed inside the block section 10 to control the flow of braking fluid. The circuit section 30 may guide the braking fluid stored in the storage section 20 to the wheel cylinder 4.

When the control section 40 detects the braking signal from the signal transmission unit 2, it may control the circuit section 30 to supply the braking fluid stored in the storage section 20 to the wheel cylinder 4. For example, the control section 40 may be installed to the block section 10 and may have a receiver that receives a braking signal from the signal transmission unit 2.

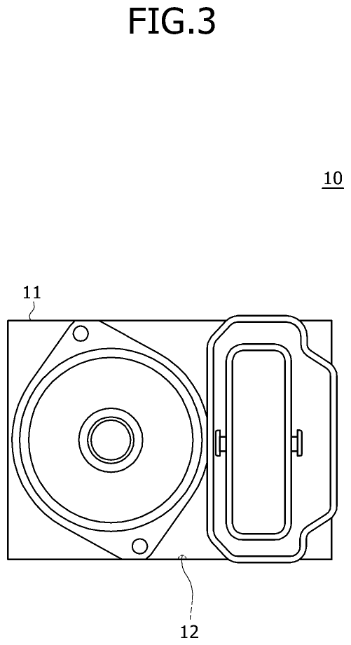

FIG. 3 is a view schematically illustrating the block section according to the embodiment of the present disclosure. Referring to FIG. 3, the block section 10 according to the embodiment of the present disclosure may include a block body 11 and a block port 12.

The block body 11 may be formed by extrusion molding and may be shaped as a square block made of machined aluminum alloy. The block body 11 may be directly connected to the wheel cylinder 4 or may be mounted on the wheel cylinder 4 through a separate connector.

The block port 12 may be formed on the block body 11 and may induce connection with the wheel cylinder 4. For example, the block port 12 may be disposed on the side of the block body 11. On the other hand, the location of the block port 12 may vary depending on the design environment.

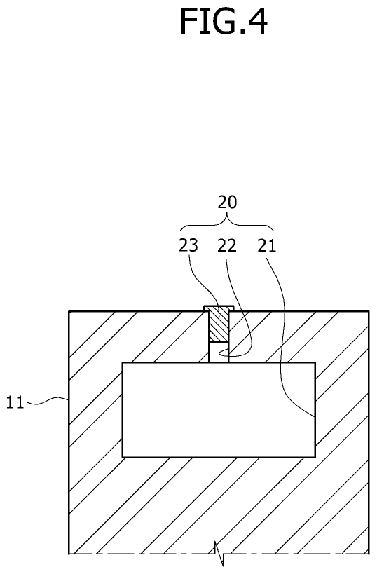

FIG. 4 is a view schematically illustrating the storage section according to the embodiment of the present disclosure. Referring to FIG. 4, the storage section 20 according to the embodiment of the present disclosure may include a storage chamber 21, a storage passage 22, and a storage plug 23.

The storage chamber 21 may be formed inside the block section 10 and may provide a space for storage of braking fluid. For example, the storage chamber 21 may define a space in a region excluding the circuit section 30 formed inside the block body 11. In addition, the storage chamber 21 may be formed separately and installed in the block body 11.

The storage passage 22 may extend from the storage chamber 21 to the side of the block section 10 to define a flow path. For example, the storage passage 22 may be a hole communicating with the storage chamber 21 on the outer surface of the block body 11.

The storage plug 23 may open or close the storage passage 22. For example, the storage plug 23 may be press-fitted into or detached from the storage passage 22 to prevent the braking fluid stored in the storage chamber 21 from leaking to the outside through the storage passage 22.

Meanwhile, the storage chamber 21 may initially receive and store braking fluid through the storage passage 22, and when the storage of the braking fluid is completed in the storage chamber 21, the storage plug 23 may close the storage passage 22.

The storage plug 23 may block the flow of fluid and permit the flow of gas to maintain the internal pressure of the storage plug 23 at the level of atmospheric pressure. The storage plug 23 may be made of a sintered metal material and may permit the flow of gas.

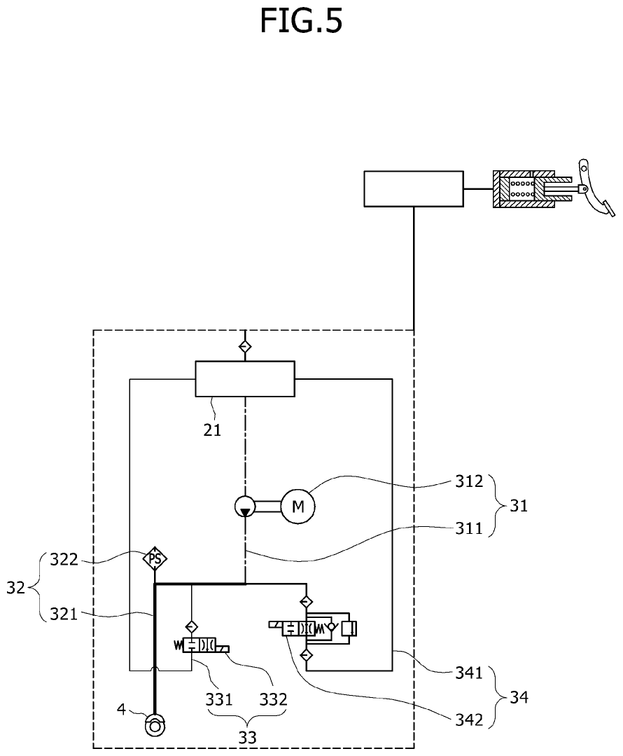

FIG. 5 is a diagram schematically illustrating the circuit section according to the embodiment of the present disclosure. Referring to FIG. 5, the circuit section 30 according to the embodiment of the present disclosure may include a first passage 31 and a second passage 32.

The first passage 31 may be connected to the storage section 20 for supply of braking fluid. For example, the first passage 31 may have one end connected to the storage chamber 21, and may be operated under the control of the control section 40 for forcing the braking fluid to be pumped.

The second passage 32 may connect the first passage 31 to the wheel cylinder 4 and guide the braking fluid stored in the storage section 20 to the wheel cylinder 4.

More specifically, the first passage 31 may include a first line 311 and a first drive part 312.

The first line 311 may be connected to the storage section 20. For example, the first line 311 may have one end connected to the storage chamber to guide the braking fluid stored in the storage chamber 21. The storage chamber 21 may be disposed at the upper portion of the storage section 20, and the first line 311 may be connected to the lower portion of the storage chamber 21.

The first drive part 312 may be formed in the first line 311 and may discharge the braking fluid stored in the storage section 20. The first drive part 312 may be an oil pump or an actuator that increases the hydraulic pressure of the braking fluid.

The second passage 32 may include a second line 321 and a second measurement part 322.

The second line 321 may connect the first passage 31 to the wheel cylinder 4. For example, the second line 321 may have one end connected to the end of the first line 311 and the other end connected to the wheel cylinder 4. The second line 321 may be in communication with the block port 12.

The second measurement part 322 may measure the pressure of the second line 321. For example, the second measurement part 322 may be a pressure sensor connected to any point of the second line 321 for pressure measurement.

The circuit section 30 according to the embodiment of the present disclosure may further include a third passage 33 and a fourth passage 34.

The third passage 33 may connect the second passage 32 to the storage section 20 for guidance of braking fluid. For example, the third passage 33 may include a third line 331 and a third valve 332.

The third line 331 may have one end connected to the second line 321 and the other end connected to the storage chamber 21. For example, the third line 331 may be connected to the second line 321 disposed between the first line 311 and the second measurement part 322.

The third valve 332 may be formed in the third line 331 to open or close the third line 331. For example, the third valve 332 may be a normally closed valve that normally closes the third line 331 and opens the third line 331 when power is applied thereto.

The fourth passage 34 may connect the first passage 31 to the storage section 20 for guidance of braking fluid. For example, the fourth passage 34 may include a fourth line 341 and a fourth valve 342.

The fourth line may have one end connected to the first line 311 connecting the first drive part 312 to the second line 321. The fourth line 341 may have the other end connected to the storage chamber 21. The fourth valve 342 may open or close the fourth line 341. The fourth valve 342 may be automatically opened and closed based on the set pressure.

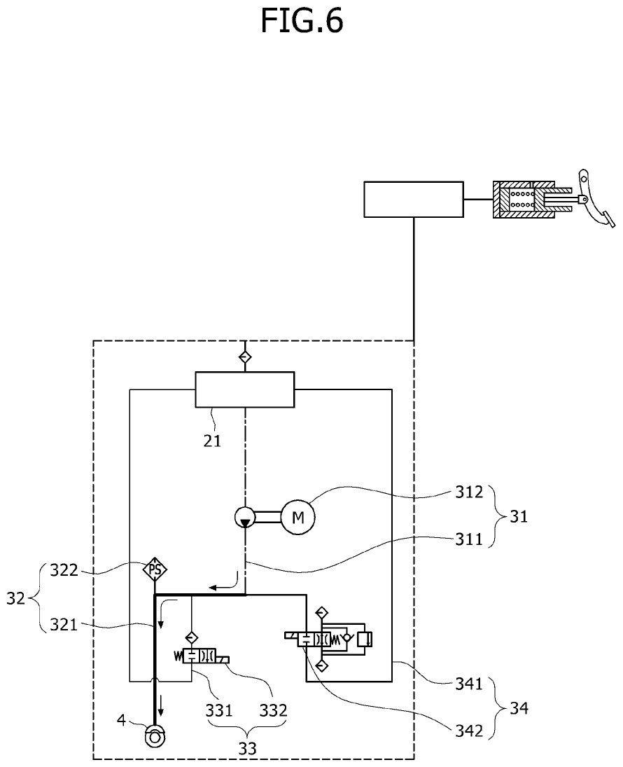

FIG. 6 is a diagram schematically illustrating an increased pressure state in the circuit section according to the embodiment of the present disclosure. Referring to FIG. 6, when braking is performed by supplying hydraulic pressure to the wheel cylinder 4, the first drive part 312 is driven. As a result, the braking fluid stored in the storage chamber 21 is supplied to the wheel cylinder 4 through the first and second lines 311 and 321. In this case, the fourth valve 342 opens and closes the fourth line 341 based on the set hydraulic pressure.

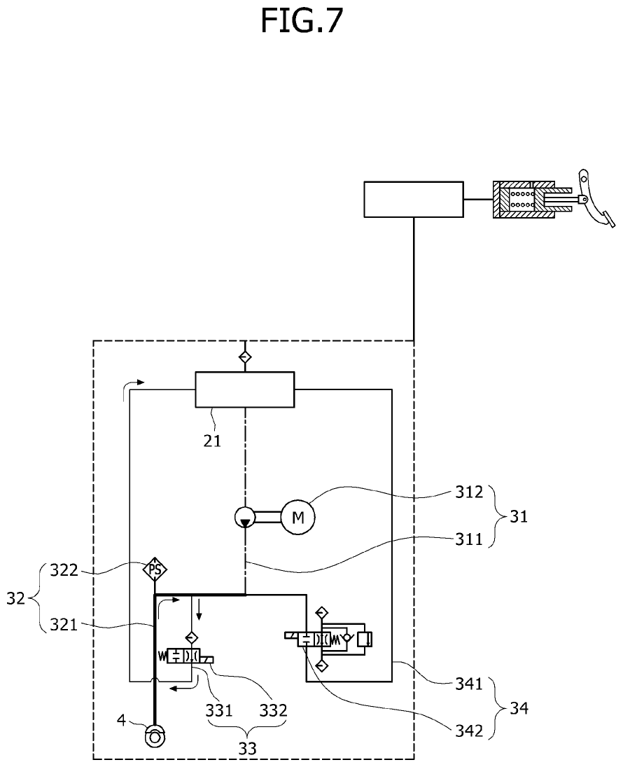

FIG. 7 is a diagram schematically illustrating a decreased pressure state in the circuit section according to the embodiment of the present disclosure. Referring to FIG. 7, when the wheel cylinder 4 requires a decrease in pressure, the third valve 332 opens the third line 331. As a result, some of the braking fluid supplied to the wheel cylinder 4 is supplied to the storage section 20 through the third line 331. In this case, the fourth valve 342 opens and closes the fourth line 341 based on the set hydraulic pressure.

In the electro-hydraulic brake system according to the embodiment of the present disclosure, when the pressure signal of the pedal unit 1 is transmitted to the braking unit 3 through the signal transmission unit 2, the braking unit 3 mounted on each wheel cylinder 4 may supply its own stored braking fluid to the wheel cylinder 4 in order to perform braking.

While the present disclosure has been described with respect to the embodiments illustrated in the drawings, it will be obvious to those skilled in the art that such embodiments are provided by way of example only. It will be understood by those skilled in the art that various modifications and other equivalent embodiments may be made without departing from the spirit and scope of the disclosure as defined in the following claims.

Therefore, the technical protection scope of the present disclosure should be defined by the following claims.

What is claimed is:

1. An electro-hydraulic brake system comprising:
a pedal unit;
a signal transmission unit configured to transmit a pressure signal of the pedal unit; and
a braking unit mounted on each wheel cylinder to supply a braking fluid to each wheel cylinder under control of the signal transmission unit.

2. The electro-hydraulic brake system of claim 1, wherein the pedal unit is pressed in response to a driver's operation or automatically in response to a braking signal in an autonomous driving mode.

3. The electro-hydraulic brake system of claim 1, wherein the signal transmission unit is further configured to transmit, to the braking unit, pressure signals digitalized from pressing speed, pressing force, and pressing time of the pedal unit.

4. The electro-hydraulic brake system of claim 1, wherein the braking unit includes:
a block section mounted on each wheel cylinder;
a storage section formed in the block section to store the braking fluid therein;
a circuit section formed in the block section to adjust the braking fluid; and
a control section configured to control the circuit section to supply the braking fluid from the circuit section to each wheel cylinder in response that the control section detects a control signal from the signal transmission unit.

5. The electro-hydraulic brake system of claim 4, wherein the block section includes:
a block body; and
a block port formed on the block body to induce connection with each wheel cylinder.

6. The electro-hydraulic brake system of claim 4, wherein the storage section includes:
a storage chamber formed inside the block section to store the braking fluid therein;
a storage passage extending from the storage chamber to a side of the block section to define a flow path; and
a storage plug configured to open or close the storage passage.

7. The electro-hydraulic brake system of claim 6, wherein the storage plug blocks a flow of fluid and permits a flow of gas to maintain an internal pressure of the storage plug at a level of atmospheric pressure.

8. The electro-hydraulic brake system of claim 6, wherein the storage plug is made of a sintered metal material.

9. The electro-hydraulic brake system of claim 6, wherein the circuit section includes:
a first passage connected to the storage section for supply of the braking fluid; and
a second passage configured to connect the first passage to each wheel cylinder and to guide the braking fluid stored in the storage section to each wheel cylinder.

10. The electro-hydraulic brake system of claim 9, wherein the first passage includes:
a first line connected to the storage section; and
a first drive part formed in the first line to discharge the braking fluid stored in the storage section.

11. The electro-hydraulic brake system of claim 10, wherein the first line is connected to a lower portion of the storage chamber.

12. The electro-hydraulic brake system of claim 10, wherein the second passage includes:
a second line configured to connect the first passage to each wheel cylinder; and
a second measurement part configured to measure a pressure of the second line.

13. The electro-hydraulic brake system of claim 12, wherein the second line connects the first line to each wheel cylinder.

14. The electro-hydraulic brake system of claim 12, wherein the circuit section includes:
a third passage configured to connect the second passage to the storage section for guidance of the braking fluid; and
a fourth passage configured to connect the first passage to the storage section for guidance of the braking fluid.

15. The electro-hydraulic brake system of claim 14, wherein the third passage includes:
a third line configured to connect the second line to the storage chamber; and
a third valve formed in the third line to open or close the third line.

16. The electro-hydraulic brake system of claim 15, wherein the third line is connected to the second line disposed between the first line and the second measurement part.

17. The electro-hydraulic brake system of claim 15, wherein the third valve is a normally closed valve configured to normally close the third line and open the third line in response that power is applied to the third valve.

18. The electro-hydraulic brake system of claim 14, wherein the fourth passage includes:
a fourth line having a first end connected to the first line disposed between the first drive part and the second line and a second end connected to the storage chamber; and
a fourth valve configured to open or close the fourth line.

19. The electro-hydraulic brake system of claim 14, wherein, in response that the first drive part is driven, the braking fluid stored in the storage chamber is supplied to each wheel cylinder through the first and second lines to perform braking.

20. The electro-hydraulic brake system of claim 14, wherein, in response that the third passage is opened, a part of the braking fluid supplied to each wheel cylinder is supplied to the storage section through the third passage to decrease a pressure in each wheel cylinder.
